(19) United States
(12) Patent Application Publication
(10) Pub. No.: US 2015/0205585 A1
(43) Pub. Date: Jul. 23, 2015

(54) DELAYED COMPILING OF SCRIPTING LANGUAGE CODE

(71) Applicants: Malte UBL, San Francisco, CA (US); John Hjelmstad, San Francisco, CA (US)

(72) Inventors: Malte UBL, San Francisco, CA (US); John Hjelmstad, San Francisco, CA (US)

(73) Assignee: GOOGLE INC., Mountain View, CA (US)

(21) Appl. No.: 13/547,908

(22) Filed: Jul. 12, 2012

Related U.S. Application Data
(60) Provisional application No. 61/655,421, filed on Jun. 4, 2012.

(51) Int. Cl. G06F 9/45; G06F 9/44; G06F 17/00; G06F 3/041

(52) U.S. Cl. CPC G06F 8/41; G06F 8/70

(57) ABSTRACT

Systems and methods for compiling and executing one or more modules written in a scripting language are provided. In some aspects, a display associated with an application, where the display includes a graphical object, is provided. An indication of intent to interact with a graphical object, is received via the graphical object. One or more modules associated with the graphical object are compiled in response to the received indication of intent to interact with the graphical object, where the one or more modules are written in the scripting language. An indication of an interaction with the graphical object is received via the graphical object. The compiled one or more modules associated with the graphical object are executed in response to the received indication of the interaction with the graphical object.

### CROSS-REFERENCE TO RELATED APPLICATIONS

The present application claims the benefit of priority under 35 U.S.C. §119 from U.S. Provisional Patent Application Ser. No. 61/655,421 entitled “DELAYED COMPILING OF SCRIPTING LANGUAGE CODE,” filed on Jun. 4, 2012, the disclosure of which is hereby incorporated by reference in its entirety for all purposes.

### FIELD

The subject technology generally relates to scripting language interfaces and, in particular, relates to delayed compiling of scripting language code.

### BACKGROUND

For some applications (e.g., webpages), a graphical component (e.g., a button) associated with one or more modules written in a scripting language may be provided. However, applications with multiple graphical components associated with multiple modules may load slowly. As the foregoing illustrates, a new approach for loading applications more quickly may be desirable.

### SUMMARY

The disclosed subject matter relates to a computer-implemented method for compiling and executing one or more modules written in a scripting language. The method includes providing a display associated with an application, where the display includes a graphical object. The method includes receiving, via the graphical object, an indication of intent to interact with the graphical object. The method includes compiling, in response to the received indication of intent to interact with the graphical object, one or more modules associated with the graphical object, where the one or more modules are written in a scripting language. The method includes receiving, via the graphical object, an indication of an interaction with the graphical object. The method includes executing, in response to the received indication of the interaction with the graphical object, the compiled one or more modules associated with the graphical object.

The disclosed subject matter relates to a machine-readable medium encoded with executable instructions for compiling and executing one or more modules written in a scripting language. The instructions include code for receiving, via a graphical object, an indication of intent to interact with the graphical object. The instructions include code for compiling, in response to the received indication of intent to interact with the graphical object, one or more modules associated with the graphical object, where the one or more modules are written in a scripting language. The instructions include code for receiving, via the graphical object, an indication of an interaction with the graphical object. The instructions include code for executing, in response to the received indication of the interaction with the graphical object, the compiled one or more modules associated with the graphical object.

The disclosed subject matter further relates to a system. The system includes one or more processors. The system also includes a memory that includes instructions that, when executed by the one or more processors, cause the one or more processors to implement a method for compiling and executing one or more modules written in a scripting language. The instructions include code to provide a display associated with an application, where the display includes a graphical object. The instructions include code to download, via a network, one or more modules associated with the graphical object, where the downloading occurs in parallel with providing the display. The instructions include code to receive, via the graphical object, an indication of intent to interact with the graphical object. The instructions include code to compile, in response to the received indication of intent to interact with the graphical object, the one or more modules associated with the graphical object, where the one or more modules are written in a scripting language. The instructions include code to receive, via the graphical object, an indication of an interaction with the graphical object. The instructions include code to execute, in response to the received indication of the interaction with the graphical object, the compiled one or more modules associated with the graphical object.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example of a system for delayed compiling of scripting language code.

FIG. 2 illustrates an example of the client computing device of FIG. 1.

FIG. 3 illustrates an example process by which one or more modules written in a scripting language may be compiled and executed.

FIG. 4 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

For some applications (e.g., webpages), a graphical component (e.g., a button) may be provided. When a user viewing the application via a client computing device selects the graphical component, precompiled code in a scripting language (e.g., JavaScript, VBScript, or Dart) may be executed. Oftentimes, the code associated with the button is compiled while the application is loaded, slowing the loading of the application on the client computing device and wasting time if the button is never selected. As the foregoing illustrates, a new approach for compiling scripting language code may be desirable.

As set forth above, in some implementations, a display in an application (e.g., a webpage in a web browser) may include a graphical object (e.g., a button) which, when selected, causes the application to execute code (e.g., in a scripting language, such as JavaScript). Compiling or parsing of the code may require excessive time or processor usage. In some implementations, the code compiled or parsed at the time the display in the application is loaded, delaying the loading of the display and decreasing the quality of the user experience. Oftentimes, the user may never select the graphical object associated with the code, causing the time or resources spent on compiling or parsing of the code to be wasted. As the foregoing illustrates, an approach for delaying compiling or parsing of code (e.g., scripting language code) may be desirable.

The subject technology is related to delayed compilation of scripting language code. In some aspects, a client computing device provides a display associated with an application (e.g., a webpage in a web browser). The display includes a graphical object (e.g., a button). The client computing device may download, via a network, one or more modules (e.g., in a scripting language) associated with the graphical object. The downloading may occur in parallel with providing the display. The client computing device receives, via the graphical object, an indication of intent to interact with the graphical object. For example, a user of the client computing device may hover a mouse over the graphical object. In response to the received indication of intent to interact with the graphical object, the client computing device compiles the one or more modules associated with the graphical object. The client computing device receives, via the graphical object, an indication of an interaction with the graphical object. For example, the user may click the mouse on the graphical object. In response to the indication of the interaction with the graphical object, the client computing device executes the compiled one or more modules associated with the graphical object.

A scripting language may refer to a high-level programming language that can be embedded into an application window, for example a web browser window displaying a webpage with hypertext markup language (HTML) code. In some examples, a scripting language may be used to provide code that is downloaded from a server and interpreted, compiled, and executed on a client computing device, affecting the data that the user sees in the application window. In some examples, a scripting language may be used to manipulate data on the server or in a database communicatively coupled to the server. Example scripting languages include JavaScript, VBScript, or Dart.

A program written in a high-level programming language (e.g., a scripting language or a non-machine-language programming language, for example, C, C++, or Java) may be interpreted by converting instructions to a non-machine-language intermediate form that can be executed. A program written in a high-level programming language may be compiled into machine language instructions, which may be executed after completion of compiling.

Advantageously, in accordance with some aspects of the subject technology, JavaScript code associated with a graphical object in a webpage displayed within a web browser window may be downloaded as soon as the webpage is opened. Upon receiving an indication of a user's intent to interact with the graphical object (e.g., hovering a mouse over the graphical object), for example, by operation of an event handler, the JavaScript code may be compiled. Upon receiving an indication of the user's interaction with the graphical object, the compiled JavaScript code may be executed. The JavaScript code may not be compiled until shortly before the code is needed (e.g., when the user is hovering the mouse over the graphical object and the user is about to select the graphical object).

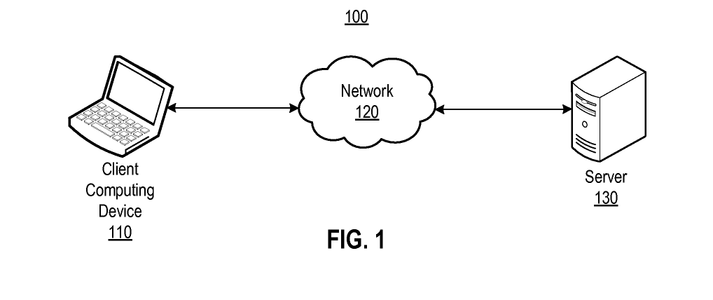

FIG. 1 illustrates an example of a system 100 for delayed compiling of scripting language code.

As shown, the system 100 includes a client computing device 110 and a server 130 connected via a network 120.

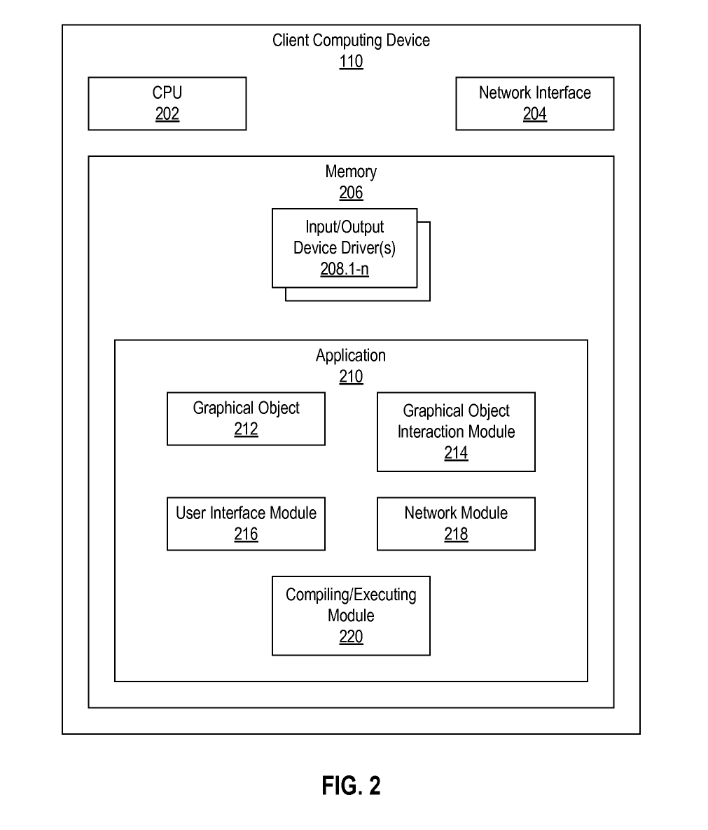

The client computing device may be a laptop computer, a desktop computer, a mobile phone, a tablet computer, a personal digital assistant (PDA), etc. The client computing device may be any device configured to connect to the network 120 and present representations of content downloaded via the network 120 via an application, for example a web browser or any other application (e.g., a mobile phone application). The client computing device 110 may download data (e.g., multimedia data or code for applications or modules, as described below) over the network 120, for example, from the server 130. The client computing device is described in more detail in conjunction with FIG. 2, below.

The network 120 may be any network that allows multiple devices to communicate and exchange data. For example, the network 120 may correspond one or more of the Internet, a cellular network, a WiFi network, a local area network (LAN), a wide area network (WAN), etc.

The server 130 may be a web server or a content server. The server may correspond to any one or more computing devices that provide data to a client computing device. The data may include multimedia data (e.g., text, images, videos, or audio files) or code executing on the client computing device (e.g., scripting language code or applications to be downloaded to the client computing device). The server may be implemented as a single machine with a single processor, a single machine with multiple processors, or as a server farm including multiple machines and multiple processors.

FIG. 2 illustrates an example of the client computing device 110 of FIG. 1.

As shown, the client computing device 110 includes a central processing unit (CPU) 202, a network interface 204, and a memory 206. The CPU 202 may include one or more processors. The CPU 202 is configured to execute computer instructions that are stored in a computer-readable medium, for example, the memory 206. The network interface 204 is configured to allow the client computing device 110 to transmit and receive data in a network, e.g., network 120 of FIG. 1. The network interface 204 may include one or more network interface cards (NICs). The memory 206 stores data or instructions. The memory 206 may be one or more of a cache unit, a storage unit, an internal memory unit, or an external memory unit. As illustrated, the memory 206 includes input/output device driver(s) 208.1-n and an application 210. While the memory 206 is illustrated as including a single application 210, the memory may include any number of applications.

The input/output device driver(s) 208.1-n may be configured to allow the client computing device 110 to interact with one or more input/output devices, for example, user input-output devices. Example input-output devices include a mouse, a keyboard, a touch screen, a display device, a speaker, a microphone, etc. The input/output device driver(s) 208.1-n may be configured to receive input associated with the input devices and to convert the input to a representation of the input that can be transmitted to an application (e.g., application 210). The input/output device driver(s) may be configured to convert a representation of output (e.g., audio or visual output) received from an application (e.g., application 210) to an output provided by an output device (e.g., a speaker or a screen). A single input/output device driver 208.k may correspond to an input device (e.g., a mouse), an output device (e.g., a speaker), or a device configured to provide both input and output (e.g., a touch screen). Example input/output device drivers include a mouse driver, a keyboard driver, a touch screen driver, a non-touch screen driver, a speaker driver, or a microphone driver.

The application 210 may be any application configured to compile received modules (e.g., modules in a scripting language) during execution of the application. For example, the application 210 may correspond to a web browser or a mobile phone application for accessing web-based content (e.g., a mobile phone application for a social networking service). As shown, the application 210 includes a representation of a graphical object 212, a graphical object interaction module 214, a user interface module 216, a network module 218, and a compiling/execution module 220.

The representation of the graphical object 212 may be, for example, an image file (e.g., a JPG file or a GIF file). In some aspects, the graphical object 212 corresponds to a button or HTML element, for example a button or HTML element for indicating preference for content or sharing content via a social network (e.g., a “Like” or “+1” button). The application 210 may be presented via an application window (e.g., a web browser window) on a display of the client computing device 110. The representation of the graphical object 212 may be provided for display within the application window.

The graphical object interaction module 214 includes instructions to be executed when the graphical object 212 is selected (e.g., touched by operation of a touch screen or clicked by operation of a mouse). The graphical object interaction module 214 may include one or more modules. The one or more modules may be written in a scripting language, for example, JavaScript, VBScript or Dart. In one example, the graphical object 212 is a button for indicating preference for content or sharing content via a social network and the graphical object interaction module 214 includes code for transmitting, to a server associated with the social network, an indication of the user's preference for the content or the user's intent to share the content via the social network. With appropriate permissions from the user, the server associated with the social network may cause the indication of the user's preference or the user's intent to share the content to be displayed to other users of the social network (e.g., the contacts of the user). The graphical object interaction module 214 may be downloaded over a network (e.g., network 120) via operation of the application 210. If the application 210 is a web browser, the graphical object interaction module 214 may be downloaded during a session when the web browser is displaying a webpage that includes the graphical object 212. In other examples, the graphical object interaction module 214 may include any other code (e.g., code for adding an item to an online shopping cart, code for sending an electronic message associated with the application, etc.).

The user interface module 216 is configured to provide a user interface associated with the application 210, for example, by communicating with the input/output device driver(s) 208.1-n to receive input via a mouse, microphone, or touch screen and to provide output via a display device or speaker. A display in the user interface associated with the application may include the graphical object 212.

The network module 218 is configured to access data, via a network (e.g., network 120) for use by the application 210 (e.g., for displaying to the user via operation of the user interface module 216). In some aspects, the network module 218 downloads, via the network, the graphical object interaction module 214. The network module 218 may operate in parallel with the user interface module 216. For example, the user interface module 216 may provide the display in the user interface associated with the application in parallel with the network module 218 downloading the graphical object interaction module 214. Alternatively, the network module 218 and the user interface module 216 may operate in series.

The compiling/executing module 220 is configured to control the compiling or executing of the graphical object interaction module 214. In one implementation, the user interface module 216 receives, via the graphical object 212, an indication of the user's intent to interact with the graphical object and notifies the compiling/execution module 220 of the received indication of intent. For example, the user interface module 216 may register an event handler that listens for events corresponding to the received indication of intent. The received indication of intent may correspond to, for example, an initiation of a touch event on the graphical object 212 or a mouse hover over the graphical object 212. In response to the received indication of intent to interact with the graphical object, the compiling/execution module 220 causes compiling of the graphical object interaction module 214. The user interface module 216 receives, via the graphical object 212, an indication of an interaction with the graphical object and notifies the compiling/execution module 220 of the received indication of the interaction. The user interface module 216 may register an event handler that listens for events corresponding the received indication of the interaction. For example, the user may select (e.g., click via operation of a mouse or touch via operation of a touch screen) the graphical object and a corresponding event may be registered. In response to the received indication of the interaction, the compiling/execution module 220 causes execution of the compiled graphical object interaction module 214. The received indication of the interaction, as set forth above, may be the same as the received indication of the user's intent to interact with the graphical object, as set forth above. In one example, both the received indication of the interaction and the received indication of the user's intent to interact correspond to the user touching (e.g., with a finger or a stylus) the graphical object on a touch screen. In some aspects, events that trigger compilation are listened for (e.g., detected by operation of the user interface module 216) in the capture phase on the outermost element of the page, allowing one or more events (e.g., an event corresponding to the indication of the interaction or the indication of the intent to interact) to be newly registered during the event handling and then still be triggered by the same event (e.g., a touch event, a mouse hover event, or a mouse click event).

In some aspects, the application 210 or the client computing device 110 does not support registering handlers for certain events (e.g., events that execute concurrently with scripting modules or with the graphical object interaction module 214). The application 210 may instead store events that take place and respond to the events when “replaying” (i.e., reviewing) the stored events.

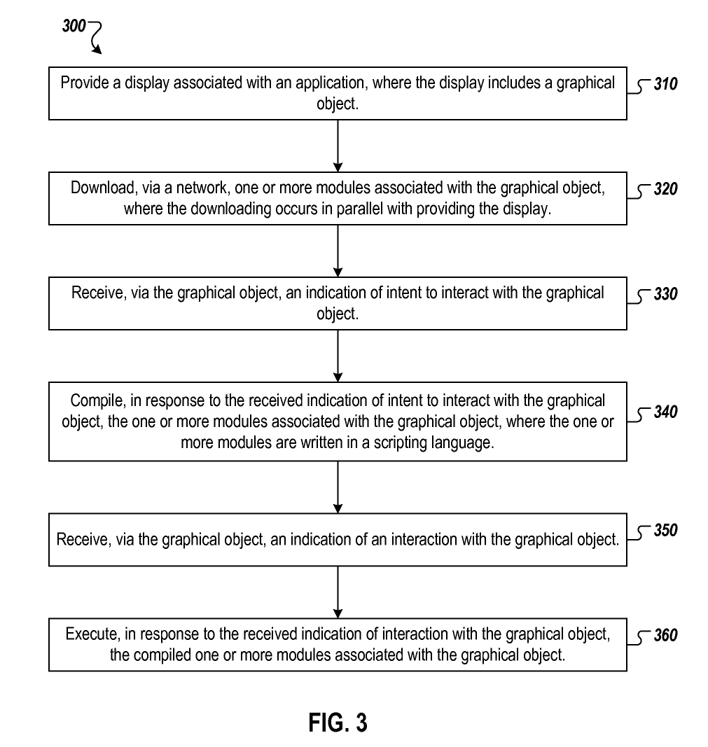

FIG. 3 illustrates an example process 300 by which one or more modules (e.g., graphical object interaction module 214) written in a scripting language may be compiled and executed.

The process 300 begins at step 310, where a computer (e.g., client computing device 110) provides a display associated with an application (e.g., application 210, which may correspond to a web browser). The display includes a graphical object (e.g., graphical object 212, which may correspond to a button). The display may be provided by a user interface module (e.g., user interface module 216) within the application.

In step 320, the computer downloads, via a network (e.g., network 120), one or more modules associated with the graphical object. The downloading (in step 320) occurs in parallel with providing the display (in step 310). The downloading may be completed by a network module (e.g., network module 218) within the application. The one or more modules may be written in a scripting language, for example, JavaScript, VBScript, or Dart. The scripting language may be associated with single threaded compiling or configured for single threaded compiling. As a result of the single threaded compiling, compiling the one or more modules may be a costly operation. Advantageously, the compiling may be carried out in an event that it is likely that the graphical object will be selected, and not at the time that the application display (e.g., webpage) is first loaded (e.g., downloaded over the network). Alternatively, the scripting language may be associated with multithreaded compiling or configured for multithreaded compiling.

In step 330, the computer receives, via the graphical object (e.g., displayed on a display device of the computer), an indication of intent to interact with the graphical object. The computer may register an event handler that listens for events corresponding to the received indication of intent. The indication of intent to interact with the graphical object may be received via the user interface module within the application. Example indications of intent to interact with the graphical object may include hovering a mouse over the graphical object, initiating a touch of the graphical object on a touch screen, single-clicking the graphical object, selecting a hot key on a keyboard corresponding to the graphical object, or zooming into the graphical object.

In step 340, the computer compiles the one or more modules associated with the graphical object in response to the received indication of intent to interact with the graphical object. The compiling may be caused by a compiling/execution module (e.g., compiling execution module 220) within the application. The one or more modules are written in a scripting language.

In step 350, the computer receives, via the graphical object (e.g., displayed on the display device of the computer), an indication of an interaction with the graphical object. The computer may register an event handler that listens for events corresponding to the received indication of the interaction. The indication of the interaction may be received via the user interface module within the application. Example indications of the interaction with the graphical object include single-clicking or double-clicking on the graphical object, touching the graphical object on a touch screen, or selecting a hot key on a keyboard corresponding to the graphical object.

The indication of the interaction with the graphical object (in step 350) may be different from the indication of intent to interact with the graphical object (in step 330). For example, the indication of intent to interact with the graphical object may include an indication of a mouse hovering over the graphical object and the indication of the interaction with the graphical object may include an indication of clicking the mouse over the graphical object. Alternatively, the indication of the interaction with the graphical object (in step 350) may include the indication of intent to interact with the graphical object (in step 330). For example, both the indication of the interaction and the indication of intent to interact may be a touch of the graphical object on the touch screen or a selection of a hot key on the keyboard corresponding to the graphical object.

In step 360, the computer executes the compiled one or more modules associated with the graphical object in response to the received indication of the interaction with the graphical object. The execution may be caused by the compiling/execution module within the application. After step 360, the process 300 ends.

In one implementation, instructions for implementing the steps 310-360 in the process 300 may be stored in a memory of the computer and may be implemented by the computer. The steps 310-360 in the process 300 may be carried out in series. Alternatively, two or more of the steps 310-360 in the process 300 may be carried out in parallel.

Below, some specific implementations of the subject technology are described using a web browsers application that downloads, compiles, or executes JavaScript module(s). However, the subject technology may be implemented in conjunction with any application that downloads, compiles, or executes any modules, for example, modules in any scripting language.

In some aspect, should a web browser or execution environment that does not support registered handlers for events that currently execute, the system may “replay” (i.e., review) events after the JavaScript has been executed.

In some aspects, the subject technology advantageously avoids parsing and executing JavaScript until the time when the JavaScript is actually needed. Some widgets may be passive in that they do not need to execute any JavaScript until the moment a user expresses explicit intent to use the widget. As used herein, the term “widget,” may refer to, for example, a graphical object, such as a button or a HTML element. A user may express intent by interacting with the widget in any way, for example, by hovering a mouse over the widget. As a result of not compiling the JavaScript during the loading of the webpage, the subject technology may decrease loading time of a webpage by whatever it takes to evaluate or compile the JavaScript code for the widget(s) on the webpage. The time to evaluate or compile the JavaScript code for the widget(s) on the webpage may depend on computer speed or on the JavaScript engine installed on the computer.

In some aspects, the subject technology advantageously reduces the performance cost on scrolling and animation pages that dynamically add widgets (i.e., graphical objects with associated JavaScript code) to a page. The subject technology may be used in, among other environments, an electronic book reader environment with a widget for scrolling (i.e., turning pages) in a book being viewed or read via an electronic book reader. The electronic book reader environment may be a webpage being viewed via a web browser, an application in a web browser, a standalone application on a general purpose computing device, or an electronic book reader application on a special purpose electronic book reader device.

In some aspects, JavaScript may be loaded using a request (for example, a XML HTTP request, where XML refers to extensible markup language and HTTP refers to hypertext transfer protocol) and the resulting JavaScript may be kept as a string in memory until evaluation is triggered by a user event. Upon triggering of such an event, all or a portion of the JavaScript that was downloaded may be evaluated or compiled. All JavaScript that is downloaded in the future (e.g., during a page refresh) may be evaluated eagerly as it arrives.

In some aspects, events may be attached for all or a portion of the ways that a user may interact with a widget. The events may include, for example, ‘mousemove,’ ‘mouseover,’ ‘mousedown,’ ‘click,’ ‘touchstart,’ ‘keydown,’ or ‘focus.’ Events may be attached to the widget's window object and may be registered in the capture phase. JavaScript evaluated in the capture phase may register events in the bubble phase which will still fire for the current events in a web browser.

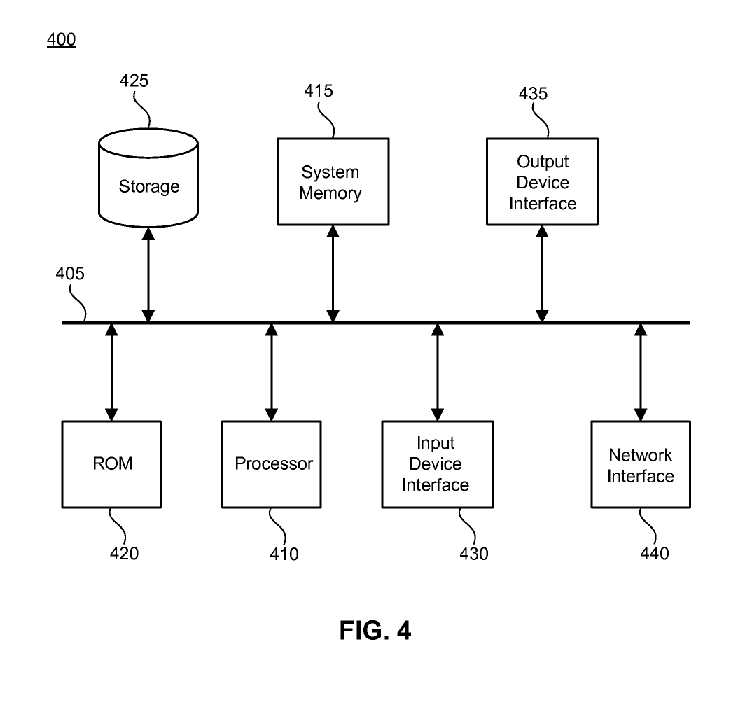

FIG. 4 conceptually illustrates an electronic system 400 with which some implementations of the subject technology are implemented. For example, one or more of the server 130, or the client computing device 110 may be implemented using the arrangement of the electronic system 400. The electronic system 400 can be a computer (e.g., a mobile phone, PDA), or any other sort of electronic device. Such an electronic system includes various types of computer readable media and interfaces for various other types of computer readable media. Electronic system 400 includes a bus 405, processing unit(s) 410, a system memory 415, a read-only memory 420, a permanent storage device 425, an input device interface 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the subject technology. The processing unit(s) can be a single processor or a multi-core processor in different implementations.

The read-only-memory (ROM) 420 stores static data and instructions that are needed by the processing unit(s) 410 and other modules of the electronic system. The permanent storage device 425, on the other hand, is a read-and-write memory device. This device is a non-volatile memory unit that stores instructions and data even when the electronic system 400 is off. Some implementations of the subject technology use a mass-storage device (for example a magnetic or optical disk and its corresponding disk drive) as the permanent storage device 425.

Other implementations use a removable storage device (for example a floppy disk, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such a random access memory. The system memory 415 stores some of the instructions and data that the processor needs at runtime. In some implementations, the processes of the subject technology are stored in the system memory 415, the permanent storage device 425, or the read-only memory 420. For example, the various memory units include instructions for delaying compiling of scripting language code in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, for example cathode ray tubes (CRT) or liquid crystal displays (LCD). Some implementations include devices for example a touchscreen that functions as both input and output devices.

Finally, as shown in FIG. 4, bus 405 also couples electronic system 400 to a network (not shown) through a network interface 440. In this manner, the electronic system 400 can be a part of a network of computers (for example a local area network (“LAN”), a wide area network (“WAN”), or an Intranet, or a network of networks, for example the Internet. Any or all components of electronic system 400 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method for compiling and executing one or more modules written in a scripting language, the method comprising:
providing a display associated with an application, wherein the display comprises a graphical object;
receiving, via the graphical object, an indication of intent to interact with the graphical object;
compiling, in response to the received indication of intent to interact with the graphical object, one or more modules associated with the graphical object, wherein the one or more modules comprise instructions to be executed when indication of an interaction with the graphical object is received, and wherein the one or more modules are written in a scripting language;
receiving, via the graphical object, the indication of the interaction with the graphical object; and
executing, in response to the received indication of the interaction with the graphical object, the compiled one or more modules associated with the graphical object.

2. The method of claim 1, further comprising:
downloading, via a network, the one or more modules associated with the graphical object, wherein the downloading occurs in parallel with providing the display.

3. The method of claim 1, wherein the application comprises a web browser.

4. The method of claim 3, wherein the application displays a webpage, and wherein the one or more modules are associated with the webpage.

5. The method of claim 1, wherein the indication of the interaction with the graphical object is different from the indication of intent to interact with the graphical object.

6. The method of claim 5, wherein the indication of intent to interact with the graphical object comprises an indication of hovering a mouse over the graphical object, and wherein the indication of the interaction with the graphical object comprises an indication of clicking the mouse over the graphical object.

7. The method of claim 1, wherein the indication of the interaction with the graphical object is identical to the indication of intent to interact with the graphical object.

8. The method of claim 7, wherein the indication of intent to interact with the graphical object and the indication of the interaction with the graphical object comprise a touch of the graphical object via a touch screen.

9. The method of claim 1, wherein the scripting language is associated with single threaded compiling.

10. A non-transitory machine-readable medium encoded with executable instructions for compiling and executing one or more modules written in a scripting language, the instructions comprising code for:
receiving, via a graphical object, an indication of intent to interact with the graphical object;
compiling, in response to the received indication of intent to interact with the graphical object, one or more modules associated with the graphical object, wherein the one or more modules comprise instructions to be executed when indication of an interaction with the graphical object is received, and wherein the one or more modules are written in a scripting language;
receiving, via the graphical object, the indication of the interaction with the graphical object; and
executing, in response to the received indication of the interaction with the graphical object, the compiled one or more modules associated with the graphical object.

11. The non-transitory machine-readable medium of claim 10, wherein the instructions further comprise code for:
providing a display associated with an application, wherein the display comprises the graphical object.

12. The non-transitory machine-readable medium of claim 11, wherein the instructions further comprise code for:
downloading, via a network, the one or more modules associated with the graphical object, wherein the downloading occurs in parallel with providing the display.

13. The non-transitory machine-readable medium of claim 11, wherein the application comprises a web browser.

14. The non-transitory machine-readable medium of claim 13, wherein the application displays a webpage, and wherein the one or more modules are associated with the webpage.

15. The non-transitory machine-readable medium of claim 10, wherein the indication of the interaction with the graphical object is different from the indication of intent to interact with the graphical object.

16. The non-transitory machine-readable medium of claim 15, wherein the indication of intent to interact with the graphical object comprises an indication of hovering a mouse over the graphical object, and wherein the indication of the interaction with the graphical object comprises an indication of clicking the mouse over the graphical object.

17. The non-transitory machine-readable medium of claim 10, wherein the indication of the interaction with the graphical object is identical to the indication of intent to interact with the graphical object.

18. The non-transitory machine-readable medium of claim 17, wherein the indication of intent to interact with the graphical object and the indication of the interaction with the graphical object comprise a touch of the graphical object via a touch screen.

19. The non-transitory machine-readable medium of claim 10, wherein the scripting language is associated with single threaded compiling.

20. A system for compiling and executing one or more modules written in a scripting language, the system comprising:
one or more hardware processors; and
a memory comprising instructions which, when executed by the one or more processors, cause the one or more processors to:
provide a display associated with an application, wherein the display comprises a graphical object;
download, via a network, one or more modules associated with the graphical object, wherein the one or more modules comprise instructions to be executed when indication of an interaction with the graphical object is received, and wherein the downloading occurs in parallel with providing the display;
receive, via the graphical object, an indication of intent to interact with the graphical object;
compile, in response to the received indication of intent to interact with the graphical object, the one or more modules associated with the graphical object, wherein the one or more modules are written in a scripting language;
receive, via the graphical object, the indication of the interaction with the graphical object; and
execute, in response to the received indication of the interaction with the graphical object, the compiled one or more modules associated with the graphical object.

21. The system of claim 20, wherein the instructions to compile the one or more modules comprise instructions which, when executed by the one or more processors, cause the one or more processors to:
convert the one or more modules from a non-machine-language intermediate form to a machine-language form.
